(19) United States
(12) Patent Application Publication
(10) Pub. No.: US 2007/0066244 A1
(43) Pub. Date: Mar. 22, 2007

(54) Method and system for assigning a receiving antenna

(75) Inventors: Kai-Pon Kao, Hsinchu City (TW); Jeff Lin, Taipei (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: VIA Technologies Inc.

(21) Appl. No.: 11/229,934

(22) Filed: Sep. 19, 2005

(51) Int. Cl. H04B 1/44; H04B 17/00

(52) U.S. Cl. 455/78; 455/226.2

(57) ABSTRACT

Method, system and apparatus for receiving antenna selection, comprising a receiving step, a determining step, an estimating step, and an assigning step. The receiving step involves receiving data and second data associated with a first antenna and a second antenna. It follows the determining step determining first and second throughputs with the first data and the second data. Next the estimating step estimating first signal deviance and second signal deviance between the received data (Dki) and a reference signal (Rki), with the first data and the second data respectively. Finally the assigning step assigning a receiving antenna among the first and the second antennas, based on the first and the second throughputs, and the first and the second signal deviances.

### BACKGROUND

The invention relates in general to wireless telecommunication system, and in particular, to assign a receiving antenna in a wireless telecommunication system.

Wireless communication is subject to adverse effects of signal fading, where the signal level at the receiver temporarily loses strength for a variety of reasons such as multipath condition of the signal, results in poor data reception, and to the extreme case, transmission disconnection.

It is known to utilize space diversity to reduce the signal fading effect. Space diversity is provided by transmitting or receiving the same signal on more than one geographically separated antennas via alternate transmission paths to guard against any particular path being affected by signal fading at any instant.

In the conventional design, the space diversity with multiple antennas has been implemented with Received Signal Strength Indication (RSSI), as demonstrated in FIG. 1, where a flowchart of selecting a receiving antenna in a dual antennas system involving antenna 0 and antenna 1 is shown.

RSSI is an indicator representing the strength of the received signal in a receiver. In FIG. 1, the selection process starts with Step S102, where a RSSI is checked for antenna 0 as RSSI0. In Step S104, the selection process is switched to antenna 0, for checking RSSI for antenna 1 as RSSI 1 in Step S106. Next, in Step S108 a comparison is made to determine if RSSI1 exceeds RSSI0. If RSSI1 exceeds RSSI0, antenna 1 remains for receiving data; otherwise in Step S110 the selection process switches back to antenna as the receiving antenna.

Despite the RSSI method in FIG. 1 offers a viable solution for some multiple antennas systems, it has the inherent limitation on the long RSSI decision period and insufficient signal quality information. In some wireless communication system, such as 802.11a and 802.11g, where the set up time prior to payload data transmission, also known as preamble time, is short, such that the RSSI decision period might surpass the preamble time easily. Furthermore, RSSI is a direct measure of the received data, and the noise information is not included. The signal quality of greater RSSI index with large noise may be no better than one with smaller RSSI index and little noise. These two issues address the necessity of seeking another mechanism for receiving antenna selection in a multiple antenna system.

Thus a method and system for assigning a receiving antenna is proposed.

### SUMMARY

The present invention is directed to a system and method for receiving antenna selection. According to one embodiment of the invention, a method for receiving antenna selection is described. The method comprises receiving first data and second data associated with a first antenna and a second antenna respectively. The method further comprises determining first and second throughputs with the first data and the second data correspondingly. Next the method comprises estimating first signal deviance and second signal deviance between the received data (Dki) and a reference signal (Rki), with the first data and the second data respectively. Finally, the method comprises assigning a receiving antenna among the first and the second antennas, based on the first and the second throughputs, and the first and the second signal deviances.

Based on another embodiment of the invention, a system for receiving antenna selection is depicted. The system comprises a first antenna module, a second antenna module a radio frequency (RF) module, and a controller module. The first antenna module receives first data, the second antenna module receives second data. The RF module is coupled to the first and the second antenna modules, and the first data and the second data are delivered through the RF module. The controller module is coupled to the RF module, the controller module comprises a throughput module, a signal deviance module, and an antenna assigning module. The throughput module is coupled to the RF module, and determines first throughput and second throughput of the first data and the second data respectively. The signal deviance module is coupled to the RF module, and estimates first signal deviance and second signal deviance between the received data (Dki) and a reference signal (Rki), with the first data and the second data respectively. Finally the antenna assigning module is coupled to the throughput module and the signal deviance module, and assigning a receiving antenna among the first and the second antennas, based on the first and the second throughputs, and the first and the second signal deviances.

According to another embodiment in the present invention, an apparatus for antenna selection is presented. The apparatus comprises first means for receiving first data and second data associated with a first antenna and a second antenna respectively; second means for determining first and second throughputs with the first data and the second data correspondingly; third means for estimating first signal deviance and second signal deviance between the received data (Dki) and a reference signal (Rki), with the first data (Dki, i=1) and the second data (Dki, i=2) respectively; and fourth means for assigning a receiving antenna among the first and the second antennas, based on the first and the second throughputs, and the first and the second signal deviances.

### BRIEF DESCRIPTION OF THE DRAWINGS

The invention will become more fully understood from the detailed description, given hereinbelow, and the accompanying drawings. The drawings and description are provided for purposes of illustration only and, thus, are not intended to be limiting of the present invention.

FIG. 1 is a flowchart of a method for assigning a receiving antenna, employing RSSI in the prior art.

FIG. 2 is a block diagram of a dual antenna system for space diversity, as an embodiment in the present invention.

FIG. 3 is a flowchart of a method for assigning a receiving antenna in a dual antenna system, as an embodiment in the present invention.

FIGS. 4 (a) and (b) is a flowchart of another method for assigning a receiving antenna in a dual antenna system, as an embodiment in the present invention.

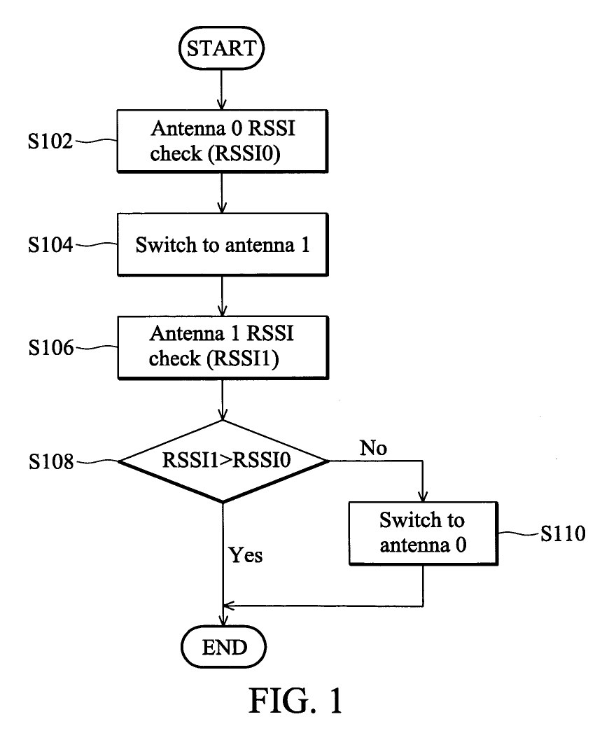

### DETAILED DESCRIPTION

Reference will now be made in detail to the embodiments of the present invention, examples of which are illustrated in the accompanying drawings.

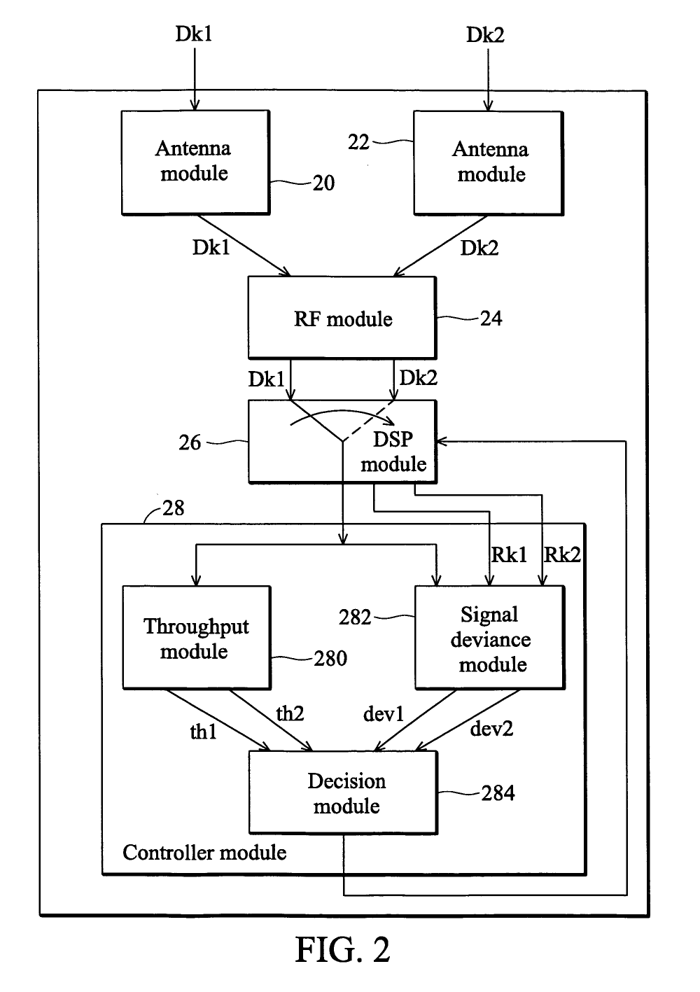

FIG. 2 illustrates a block diagram of a dual antenna system for space diversity, as an embodiment in the present invention. As displayed in FIG. 2, the system comprises first antenna module 20, second antenna module 22, radio frequency module 24, digital signal process (DSP) module 26, and controller module 28. First antenna module 20 and second antenna module 22 are coupled to RF module 24. RF module 24 is coupled to DSP module 26, which in turn is coupled to controller module 28.

The first antenna module 20 receives first data Dk1 through a transmission medium. Concurrently, the 'second antenna module 22 also receives second data Dk2 from a transmission medium. The first and second data Dk1 and Dk2 are originated from the same data source, and are correlated. The first and second data Dk1 and Dk2 are delivered through the RF module 24 and directed to controller module 28 via DSP module 26. DSP module 26 may accept either the first data Dk1 or the second data Dk2, and may include an equalizer module processing the accepted data. Once the first or the second data reach controller module 28, controller module 28 starts to process data Dk1 and Dk2 for assigning a receiving antenna for subsequent data processing.

Controller module 28 incorporates throughput module 280, signal deviance module 282, and decision module 284. Throughput module 280 is coupled to DSP module 26, acquires the data from DSP module 26, and determines the throughput of the data accordingly. Signal deviance module 282 is coupled and accepts the data from DSP module 26, for estimating the signal deviance of data Dk1 and Dk2 with respect to the reference signal Rk1 and Rk2, respectively. Reference signal Rk1 and Rk2 may be originated internally or externally to signal deviance module 282. Both of throughput module 280 and signal deviance module 282 are coupled to the decision module 284, renders the resultant throughput and signal deviance to assigning module 284. Decision module 284 then decides a receiving antenna for the dual antenna system, based on the throughput and the signal deviance of the first and the second data Dk1 and Dk2.

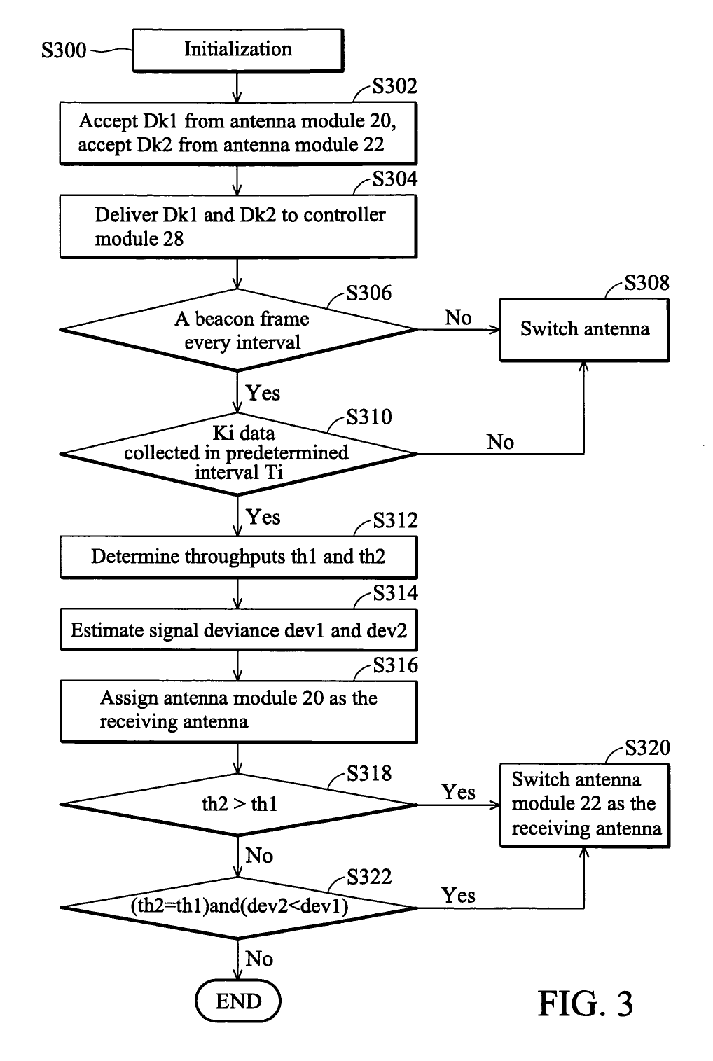

FIG. 3 indicates a flowchart of a method for assigning a receiving antenna, as an embodiment of the present invention. The method utilizes the dual antennas system in FIG. 2 to demonstrate the operation of antenna assigning process. For explanatory purpose, this method addresses IEEE 802.11 (a) (b) (g) system for wireless local area network (WLAN), as an illustration of the method. Nevertheless, people in the art may adapt the embodiment where appropriate for other wireless telecommunication technologies and system.

In Step S300, after initialization of the system, the first antenna module 20 is set as the default receiving antenna. It follows by Step S302, where the first data Dk1 is accepted at first antenna module 20, while the second data Dk2 is at second antenna module 22 within a predetermined time interval. Antenna modules 20 and 22 collect a predetermined quantity K1 and K2 of WLAN data to derive a good representative of the reception quality associated with each antenna respectively, where K1 is always much greater than K2. Further, the data collection for the first data Dk1 may be terminated if the predetermined quantity K1 is not collected within a predetermined time interval T1, instead a predetermined quantity K2 of the data Dk2 must be collected within a predetermined time interval T2. Once the second data can not meet predetermined quantity K2 within the time interval T2, the antenna selection is switched back to first antenna module 20 to maintain the connection status.

In Step S304, data Dk1 and Dk2 traverse through radio frequency module 24 and DSP module 26 sequentially to controller module 28. Controller module 28 receives the first data Dk1 associated with the first antenna, and the second data Dk2 associated with the second antenna respectively.

In conjunction with Step S304, a beacon frame, transmitted periodically from an access point (AP) in an infrastructure WLAN network, is monitored regularly in a specified beacon interval in Step S306, to ensure validity of the data reception. Failures of picking up a beacon frame in a maximum beacon interval implies poor data reception in antenna module 20, the antenna selection process is thus switching to antenna module 22 in Step S308.

In Step S310, when antenna module 20 or 22 fails to collect K1 and K2 data samples in the predetermined time interval T1 and T2 correspondingly, it is obviated from the antenna selection process. On the contrary, the antenna selection process proceeds upon completion of the K1 and K2 sample collection in the predetermined time interval T1 and T2.

Controller module 28 computes data Dk1 and Dk2 to render parameters indicating qualitative and qualitative attributes of the data associated with antennas module 20 and 22 accordingly. Based on the parameters, it arrives a decision to the receiving antenna in the dual antenna system.

Thus in Step S312 throughput module 280 determines the first and the second throughputs th1 and th2 with data Dk1 and Dk2 correspondingly. Since data may be transmitted with different data rate in each channel in OFDM system, throughput module 280 evaluates count of the data received for each data rate, and represents the first throughput th1 and the second throughput th2 as a data rate with maximum count of data Dk1 and Dk2 respectively.

Signal deviance module 282 then estimates the first signal deviance dev1 and the second signal deviance dev2 with data Dk1 and Dk2 in Step S314. The signal deviance measures the difference of the data (Dki) from a reference signal (Rki), where i represents an index number for the antenna modules, Dk1 and Dk2 represent data for antenna module 20 and 22 respectively, and Rk1 and Rk2 represent reference signal for Dk1 and Dk2 correspondingly. DSP module 26 generates reference signals Rki based on data Dki, and transfers reference, signals Rki to signal deviance module 284 to compute the signal deviance of Data Dki. As reference signal Rki corresponds to an ideal signal, the deviance from it indicates the signal quality of the data. The greater value of signal deviance is, the worse signal quality of data. This signal deviance may employ Error Vector Magnitude (EVM) in some embodiments of the invention, given by:

$$EVM = \frac{{\sum }_{ki = 1}^{Ki} \vert {D}_{ki} - {R}_{ki} \vert}{Ki} \qquad ( 1 )$$

where k is the sample number, Ki is the predetermined sample quantity, i represents i^{th} antenna module, Dki is the k^{th} vector data signal in i^{th} antenna module, and Rki is the vector reference signal for Dki.

Alternatively, since signal deviance dev1 and dev2 are used as a comparison parameter in the invention, it is the relative value rather than the absolute value that concerns the design. As a result a simpler form of equation (1) may be adapted as an alternative of the EVM, given by:

$$\frac{{\sum }_{ki = 1}^{Ki} [ \vert {D}_{ki}^{I} - {R}_{ki}^{I} \vert + \vert {D}_{ki}^{Q} - {R}_{ki}^{Q} \vert ]}{Ki} \qquad ( 2 )$$

where Dₖᵢ^{I} and Rₖᵢ^{I} is the real part of Dₖᵢ and Rₖᵢ, and Dₖᵢ^{Q} and Rₖᵢ^{Q} is the image part of Dₖᵢ and Rₖᵢ

Other variations of signal deviance is possible, people in the art may make appropriate modifications to the signal deviance with the same principle bearing in minds.

Up to this point, decision module 284 may assign the receiving antenna based on throughput th1 and th2, and signal deviance dev1 and dev2. In Step S316, decision module 284 assigns antenna module 20 as the receiving antenna initially, it may switch antenna module 22 to be the receiving antenna according to throughput th1 and th2, and signal deviance dev1 and dev2.

In Step S318, throughput th1 is compared with throughput th2. As a result, antenna module 22 is appointed as the receiving antenna in Step S320 if throughput th2 exceeds throughput th1. Greater second throughput th2 suggests better data reception at the second antenna, therefore the employment of antenna module 22 brings forth better data utilization.

If, on the other hand, the second throughput th2 shares the same value as throughput th1, the signal deviance is taken into further consideration in Step S322. Antenna module 22 is still the receiving antenna, provided the second signal deviance dev2 possess a smaller value than signal deviance dev1. In other words, under the same throughput, if the second data Dk2 yields better signal quality than data Dk1, antenna module 22 is designated as the receiving antenna.

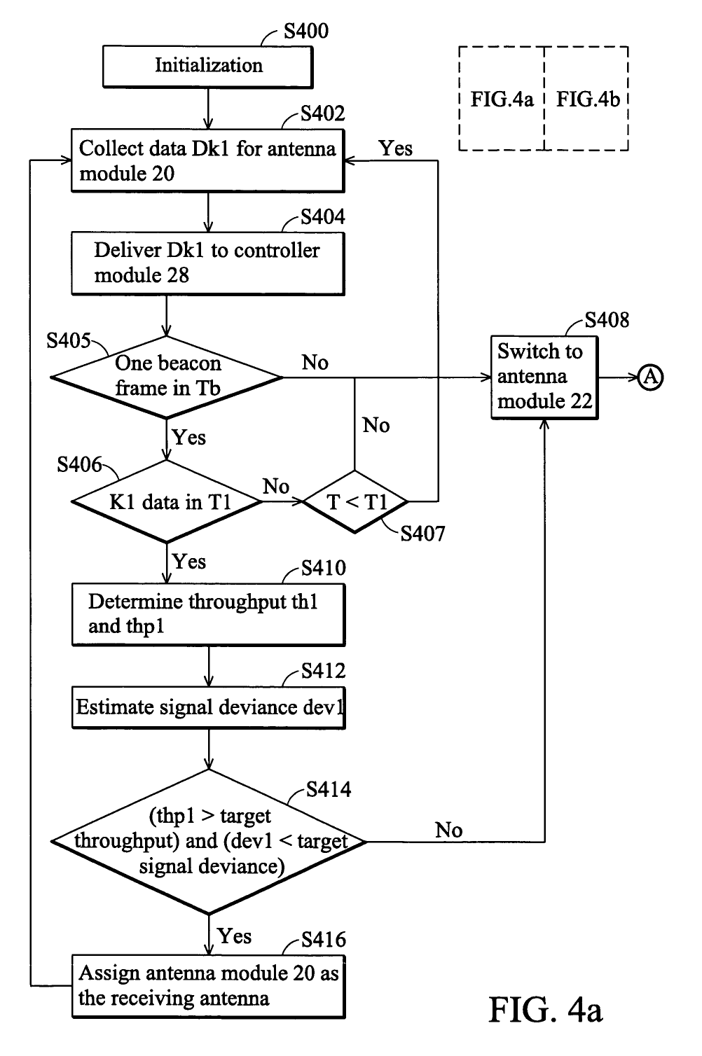

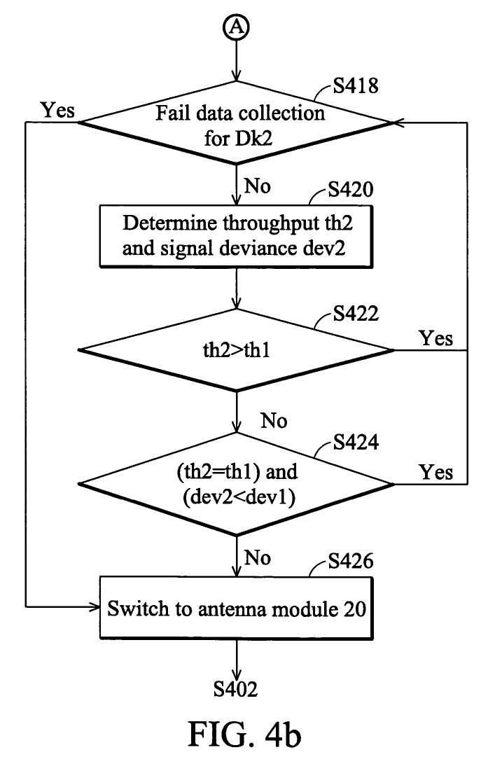

FIGS. 4 (a) and (b) display a flowchart of a method for selecting a receiving antenna, according to another embodiment of the invention. The method utilizes the system in FIG. 2 with Antenna module 20 as the default antenna.

Upon initialization of the system, the first data Dk1 is accepted at first antenna module 20 in Step S402.

In Step S404, data Dk1 is delivered to controller module 28 via radio frequency module 24 and DSP module 26. DSP module 26 switches to the connection to first antenna module 20, and direct data Dk1 to controller module 28.

A beacon frame is monitored in antenna module 20 in a maximum beacon interval Tb. In Step S405, if no beacon frame is detected in a maximum beacon interval Tb, decision module 284 immediately exempts antenna module 20 from the antenna selection process, instead DSP module 26 switches to the second data Dk2 from antenna module 22, as indicated in Step S408. If one beacon frame is detected in a maximum beacon interval Tb in Step S405, Step S406 then tests if antenna module 20 collects a first quantity K1 of data Dk1 in first time interval T1. If data Dk1 is less than the first quantity K1, then Step S407 determines if data collection time T exceeds the first time interval T1. If data collection time T is still within the first time interval T1, the antenna selection process loops back to Step S402 for collecting more data Dk1, otherwise antenna module 22 in Step S408 is utilized.

In Step S410, if Ki data is received in time interval T1, throughput module 280 determines the throughput th1 of data Dk1. Throughput module 280 evaluates count of data Dk1 received for each data rate, represents the data rate with maximum count as the first throughput th1, and determines the count with a target data rate as primary throughput thp1. In this embodiment, for example, the target data rate is 54 Mbps, and primary throughput thp1 is the count of data Dk1 at 54 Mbps.

It follows by Step S412, where the signal deviance dev1 is derived in signal deviance module 282, with accordance to the data and a reference data. Equations (1) and (2) are provided as examples to compute signal deviance dev1.

In Step S414, if primary throughput thp1 exceeds a target throughput, and signal deviance dev1 is less than a target signal deviance, decision module 284 assigns antenna module 20 as the receiving antenna in Step S416, else DSP module 26 switches to the second data Dk2, as Step S408. In this embodiment the target throughput is K1/2, and the target signal deviance may be a threshold value designated by the implementer.

In Step S408, DSP module 26 switches to data Dk2 from the second antenna module 22, and the antenna selection process is proceeded by Step S418.

In Step S418, if a failure condition of Dk2 data collection is met, DSP module 26 switches back to the first data Dk1. The failure condition may be met if antenna module 22 fails to collect a second quantity K2 of data Dk2 in second time interval T2, or fails to receive a beacon frame in maximum beacon interval Tb.

If the condition in Step S418 is not met, the antenna selection process is directed to Step S402, else controller module 28 computes data Dk2 to render a second throughput th2 and a second signal deviance dev2 associated with antenna module 22, as indicated in Step S420. Throughput module 280 evaluates count of the data received for each data rate, and the second throughput th2 is represented by a data rate with maximum count of the data. Signal deviance module 282 estimates the second signal deviance dev2 based on data Dk2 and reference signal Rk2.

To this point, decision module 284 may select the receiving antenna based on throughput th1 and th2, and signal deviance dev1 and dev2. In Step S422 throughput th1 is compared with throughput th2. As a result, antenna module 22 is appointed as the receiving antenna in Step S426 if throughput th2 exceeds throughput th1. If the second throughput th2 shares the same value as throughput th1, the signal deviance is taken into further consideration in Step S424.

In Step S424, if the second signal deviance dev2 is less than signal deviance dev1, decision module 284 selects antenna module 22 as the receiving antenna, else decision module 284 issues a control signal to DSP module 26 for switching back to the fist data Dk1 in Step S426. In other words, under the same throughput, if the second data Dk2 yields better signal quality than data Dk1, antenna module 22 is designated as the receiving antenna.

In Step S426, DSP module 26 switches to first antenna module 20, the antenna selection process loops back to S402 collecting data Dk1. The antenna selection process continues until the process is terminated.

An apparatus for antenna selection may be implemented according to another embodiment in the present invention. The apparatus comprises first means for receiving first data and second data associated with a first antenna and a second antenna respectively; second means for determining first and second throughputs with the first data and the second data correspondingly; third means for estimating first signal deviance and second signal deviance between the received data (Dki) and a reference signal (Rk), with the first data (Dki, i=1) and the second data (Dki, i=2) respectively; and fourth means for assigning a receiving antenna among the first and the second antennas, based on the first and the second throughputs, and the first and the second signal deviances.

Although some embodiments of the present invention are provided in the proceeding paragraphs, it should be understood that various modifications and combinations of the illustrative embodiment, as well as other embodiments of the invention, will be apparent to skills in the art upon reference to the description, to fulfill their requirement for other multiple antenna systems and wireless network technologies.

The foregoing description of several embodiments have been presented for the purpose of illustration and description. Obvious modifications or variations are possible in light of the above teaching. The embodiments were chosen and described to provide the best illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

What is claimed is:

1. A method for antenna selection, comprising:
receiving first data and second data associated with a first antenna and a second antenna respectively;
determining first and second throughputs with the first data and the second data correspondingly;
estimating first signal deviance and second signal deviance between the received data (Dki) and a reference signal (Rki), with the first data (Dki, i=1) and the second data (Dki, i=2) respectively; and
assigning a receiving antenna among the first and the second antennas, based on the first and the second throughputs, and the first and the second signal deviances.

2. The method of claim 1, wherein the receiving step comprises:
receiving a first quantity (Ki, i=1) of the first data within a first interval, and a second data quantity (Ki, i=2) of the second data within a second interval.

3. The method of claim 1, wherein the assigning step comprises:
assigning the first antenna as the receiving antenna;
switching the second antenna as the receiving antenna if the second throughput exceeds the first throughput; and
switching the second antenna as the receiving antenna if the first throughput equals to the second throughput, and the first signal deviance exceeds the second signal deviance.

4. The method of claim 1, wherein the first throughput is data rate for most of the first data, and the second throughput is data rate for most of the second data.

5. The method of claim 3, wherein the assigning step further comprises:
switching the second antenna as the receiving antenna if a beacon data is not received in a beacon interval.

6. The method of claim 2, wherein the signal deviance is an error vector magnitude (EVM), given by:
$$EVM = \frac{{\sum }_{ki = 1}^{Ki} \vert {D}_{ki} - {R}_{ki} \vert}{Ki}$$

7. The method of claim 2, wherein the signal deviance is given by:
$$\frac{{\sum }_{ki = 1}^{Ki} [ \vert {D}_{ki}^{I} - {R}_{ki}^{I} \vert + \vert {D}_{ki}^{Q} - {R}_{ki}^{Q} \vert ]}{Ki}$$
where Dₖᵢ^{I} and Rₖᵢ^{I} is the real part of Dₖᵢ and Rₖᵢ, and Dₖᵢ ^{Q} and Rₖᵢ^{Q} is the image part of Dₖᵢ and Rₖᵢ

8. A system for receiving antenna selection, comprising:
a first antenna module receiving first data;
a second antenna module receiving second data;
a radio frequency (RF) module coupled to the first and the second antenna modules, and the first data and the second data are delivered through the RF module; and
a controller module coupled to the RF module, comprising:
a throughput module coupled to the RF module, and determining first throughput and second throughput of the first data and the second data respectively;
a signal deviance module coupled to the RF module, and estimating first signal deviance and second signal deviance between the received data (Dki) and a reference signal (Rki), with the first data (Dki, i=1) and the second data (Dki, i=2) respectively; and
an antenna assigning module coupled to the throughput module and the signal deviance module, and assigning a receiving antenna among the first and the second antennas, based on the first and the second throughputs, and the first and the second signal deviances.

9. The system of claim 8, wherein the first and second antenna modules comprise receiving first and second data quantities (Ki) of the first data (Ki, i=1) and the second data (Ki, i=2) within first and second intervals respectively.

10. The system of claim 8, wherein the antenna assigning module assigns the first antenna as the receiving antenna, switches the second antenna as the receiving antenna if the second throughput exceeds the first throughput, and switches the second antenna as the receiving antenna if the first throughput equals to the second throughput, and the first signal deviance exceeds the second signal deviance.

11. The system of claim 8, wherein the first throughput is data rate for most of the first data, and the second throughput is data rate for most of the second data.

12. The system of claim 10, wherein the antenna assigning module further comprises switching the second antenna as the receiving antenna if a beacon data is not received in a beacon interval.

13. The system of claim 9, further comprising an DSP module coupled to the RF module and the controller module, the first and the second data are directed through the DSP module to the controller module, wherein the signal deviance is given by:
$$EVM = \frac{{\sum }_{ki = 1}^{Ki} \vert {D}_{ki} - {R}_{ki} \vert}{Ki}$$

14. An apparatus for antenna selection comprising:
means for receiving first data and second data associated with a first antenna and a second antenna respectively;
means for determining first and second throughputs with the first data and the second data correspondingly;
means for estimating first signal deviance and second signal deviance between the received data (Dki) and a reference signal (Rki), with the first data (Dki, i=1) and the second data (Dki, i=2) respectively; and
means for assigning a receiving antenna among the first and the second antennas, based on the first and the second throughputs, and the first and the second signal deviances.

15. The apparatus of claim 14, wherein the means for receiving comprises:
means for receiving a first quantity (Ki, i=1) of the first data within a first interval, and a second data quantity (Ki, i=2) of the second data within a second interval.

16. The apparatus of claim 14, wherein the means for assigning comprises:
means for assigning the first antenna as the receiving antenna;
means for switching the second antenna as the receiving antenna if the second throughput exceeds the first throughput; and
means for switching the second antenna as the receiving antenna if the first throughput equals to the second throughput, and the first signal deviance exceeds the second signal deviance.

17. The apparatus of claim 14, wherein the first throughput is data rate for most of the first data, and the second throughput is data rate for most of the second data.

18. The apparatus of claim 16, wherein the means for assigning further comprises:
means for switching the second antenna as the receiving antenna if a beacon data is not received in a beacon interval.

19. The apparatus of claim 15, wherein the signal deviance is an error vector magnitude (EVM), given by:
$$EVM = \frac{{\sum }_{ki = 1}^{Ki} \vert {D}_{ki} - {R}_{ki} \vert}{Ki}$$

20. The apparatus of claim 15, wherein the signal deviance is given by:
$$\frac{{\sum }_{ki = 1}^{Ki} [ \vert {D}_{ki}^{I} - {R}_{ki}^{I} \vert + \vert {D}_{ki}^{Q} - {R}_{ki}^{Q} \vert ]}{Ki} ,$$
where Dₖᵢ^{I} and Rₖᵢ^{I} is the real part of Dₖᵢ and Rₖᵢ, and Dₖᵢ^{Q} and Rₖᵢ^{Q} is the image part of Dₖᵢ and Rₖᵢ
